(19) United States
(12) Patent Application Publication
(10) Pub. No.: US 2003/0055946 A1
(43) Pub. Date: Mar. 20, 2003

(54) Network monitoring apparatus, computer-readable medium storing a network monitoring program, and network monitoring method

(76) Inventor: Kouji Amemiya, Tokyo (JP)

Correspondence Address: RYUKA, 1-24-12 SHINJUKU, SIXTH FLOOR, TOSHIN BUILDING, SHINJUKU-KU, TOKYO, 160-0022, JP

(21) Appl. No.: 09/683,078

(22) Filed: Nov. 15, 2001

(30) Foreign Application Priority Data
Aug. 21, 2001 (JP) 2001-250707

(51) Int. Cl. G06F 15/173

(52) U.S. Cl. 709/224

(57) ABSTRACT

A network monitoring apparatus for monitoring an interconnecting device that interconnects communication in a computer network. A first storage unit stores a plurality of notifications to notify of each of a plurality of operations in the interconnecting device, respectively. A detection unit that detects the operations in the interconnecting device and a notification unit that selects a notification stored in the first storage unit based on a detected operation to notify of the operation of the interconnecting device by the selected notification.

### CROSS REFERENCE TO RELATED APPLICATIONS

This patent application claims priority from a Japanese patent application, No. 2001-250707 filed on Aug. 21, 2001, the contents of which are incorporated herein by reference.

### BACKGROUND OF INVENTION

1. Field of the Invention

The present invention relates to a network monitoring apparatus, a computer-readable medium storing a network monitoring program, and a network monitoring method thereof. More particularly, the present invention relates to a network monitoring apparatus that provides notification of an operation of a communication device in a computer network by selecting a predetermined notification from a plurality of stored notifications based upon a detected operation of the communication device.

2. Description of the Related Art

Japanese Patent Application Laid-Open No. 11-31114 discloses a remote network management system that monitors the status of a communication device communicating in a computer network by displaying an image of the communication device using GUI (graphical user interface). Further, Japanese Patent Application Laid-Open No. 11-161587 discloses a network connection equipment management application that lights up an image of an LED of an interconnecting device to be managed using GUI, which is similar to an LED of a connection port equipped by the interconnecting device such as a switching hub, router, or the like, to indicate whether or not communication is possible.

However, if only an image of an equipment to be monitored is displayed, it is difficult for an administrator of the computer network to rapidly and accurately obtain information of what kind of fault has occurred in the equipment being monitored. Moreover, communication traffic for a network monitoring apparatus to communicate with the equipment to be monitored is increased by always monitoring a plurality of communication devices that communicate in the computer network, thereby causing a problem of an excessive communication load being applied to the whole computer network.

### SUMMARY OF INVENTION

Therefore, it is an object of the present invention to provide a network monitoring apparatus, a computer-readable medium storing a network monitoring program, and a method thereof, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, a network monitoring apparatus for monitoring an interconnecting device that interconnects communication in a computer network, comprises: a first storage unit having a plurality of notifications stored therein corresponding to each of a plurality of operations in the interconnecting device, respectively; a detection unit that detects each of the operations in the interconnecting device; and a notification unit that selects one of the notifications stored in the first storage unit based on the detected operation to notify of the detected operation of the interconnecting device by the selected notification.

The detection unit may detect the each of the plurality of operations in the interconnecting device at a different interval.

An interval for detecting whether or not the interconnecting device is operating may be shorter than an interval for detecting communication traffic in the interconnecting device.

The detection unit may transmit a detection signal to the interconnecting device and may detect the operations of the interconnecting device based on a response signal to the detection signal from the interconnecting device.

The network monitoring apparatus may further comprise a second storage unit for storing an information signal indicating an operation of the interconnecting device, the information signal being received from the interconnecting device and stored corresponding to a time when the information signal is received, in which the detection unit detects the operations of the interconnecting device by referring to the information signal stored in the second storage unit.

The detection unit may detect the each of the operations of a plurality of the interconnecting devices at a different interval.

the interconnecting device may have a plurality of connection ports to which a plurality of communication devices are respectively connected, and the detection unit may detect a communication status of each of the plurality of connection ports in the interconnecting device at a different interval.

The notification unit may transmit an e-mail to a predetermined e-mail address as the selected one of the notifications to notify of the detected operation of the interconnecting device.

According to the second aspect of the present invention, a network monitoring apparatus for monitoring a plurality of communication devices that communicate in a computer network, comprises: a detection unit that detects an operation of a predetermined communication device of the plurality of communication devices; a scheduling unit that schedules a monitoring interval, which is an interval for monitoring the predetermined communication device, based on the operation detected by the detection unit; and a monitoring unit for monitoring the predetermined communication device based on the monitoring interval set by the scheduling unit.

The detection unit may detect a type of the predetermined communication device as the operation of the predetermined communication device and the scheduling unit may schedule the monitoring interval for the predetermined communication device based on the type of the predetermined communication device detected by the detection unit.

The scheduling unit may schedule the monitoring interval for a server computer type of the predetermined communication device to be shorter than the monitoring interval for a client computer type of the predetermined communication device.

The detection unit may detect communication traffic of the predetermined communication device as the operation of the predetermined communication device and the scheduling unit may schedule the monitoring interval for the predetermined communication device based on the communication traffic detected by the detection unit.

The predetermined communication device may have a plurality of connection ports to which a plurality of communication devices are respectively connected, and the scheduling unit may schedule a monitoring interval, which is a corresponding interval for monitoring a communication status of each of the plurality of connection ports of the predetermined communication device, respectively.

The detection unit may detect a corresponding communication device type connected to each of the plurality of connection ports, respectively, as the operation of the predetermined communication device, and the scheduling unit may respectively schedule the monitoring interval of each of the plurality of connection ports based on the corresponding communication device type detected by the detection unit.

The scheduling unit may schedule the monitoring interval for a first connection port to which a server computer is connected to be shorter than the monitoring interval for a second connection port to which a client computer is connected.

The detection unit may detect respective communication traffic for each of the plurality of connection ports and the scheduling unit may respectively schedule the monitoring interval for each of the plurality of connection ports based on the communication traffic detected by the detection unit.

According to the third aspect of the present invention, a computer-readable medium storing a network monitoring program for a computer to monitor an interconnecting device that interconnects communication in a computer network, the program comprises: a storage module operable to make the computer store a plurality of notifications to notify of each of a plurality of operations in the interconnecting device, respectively; a detection module operable to make the computer detect each of the operations in the interconnecting device; and a notification module operable to make the computer select one of the notifications stored in the computer based on the detected operation and to notify of the detected operation in the interconnecting device by the selected notification.

The detection module may be operable to make the computer detect the each of the plurality of operations in the interconnecting device at a different interval.

The detection module may make the computer detect each of the plurality of operations in a plurality of the interconnecting devices at a different interval.

According to the fourth aspect of the present invention, a computer-readable medium storing a network monitoring program for a computer that monitors a plurality of communication devices communicating in a computer network, the program comprises: a detection module operable to make the computer detect an operation of a predetermined communication device of the plurality of communication devices; a scheduling module operable to make the computer schedule a monitoring interval, which is an interval for monitoring the predetermined communication device, based on the operation detected by the computer; and a monitoring module operable to make the computer monitor the predetermined communication device based on the monitoring interval scheduled by the scheduling module.

The detection module may be operable to make the computer detect a type of the predetermined communication device as the operation of the predetermined communication device; and the scheduling module may be operable to make the computer schedule the monitoring interval for the predetermined communication device based on the type of the predetermined communication device detected by the computer.

The detection module may be operable to make the computer detect communication traffic of the predetermined communication device; and the scheduling module may be operable to make the computer schedule the monitoring interval of the predetermined communication device based on the communication traffic detected by the computer.

According to the fifth aspect of the present invention, a network monitoring method of monitoring an interconnecting device that interconnects communication in a computer network, the method comprises: storing a plurality of notifications to notify of each of a plurality of operations in the interconnecting device, respectively; detecting an operation in the interconnecting device; and selecting one of the stored notifications based on the detected operation and notifying of the detected operation of the interconnecting device by the selected notification.

According to the sixth aspect of the present invention, a network monitoring method of monitoring a plurality of communication devices that communicate in a computer network, the method comprises: detecting an operation of a predetermined communication device of the plurality of communication devices; scheduling a monitoring interval, which is an interval at which the predetermined communication device is monitored, based on the detected operation; and monitoring the predetermined communication device based on the monitoring interval.

This summary of the present invention does not necessarily describe all necessary features so that the invention may also be a sub-combination of these described features.

### BRIEF DESCRIPTION OF DRAWINGS

FIG. 1 is a schematic representation of a computer network 100 according to the present invention.

FIG. 2 depicts schematically components of a network monitoring apparatus 10 according to the present invention.

FIG. 3 shows a data format of a notification file stored in a first storage unit 104 of the network monitoring apparatus 10 according to the present invention.

FIG. 4 shows a data format of a trap information file stored in a second storage unit 110 of the network monitoring apparatus 10 according to the present invention.

FIG. 5 shows a data format of a monitoring interval file stored in a third storage unit 112 of the network monitoring apparatus 10 according to the present invention.

FIG. 6 is a flowchart of one example of a network monitoring method according to the present invention.

FIG. 7 is a flowchart of a monitoring condition changing process (SI 04) of the network monitoring method in FIG. 6.

FIG. 8 is one example of a monitoring table displayed by a display unit 105 of the network monitoring apparatus 10 according to the present invention.

FIG. 9 is a flowchart of an interval monitoring process (S114) of the network monitoring method in FIG. 6.

FIG. 10 is a schematic diagram showing hardware components in the network monitoring apparatus 10 according to the present invention.

### DETAILED DESCRIPTION

The invention will now be described based on preferred embodiments, which do not intend to limit the scope of the present invention, but rather to exemplify the invention. All of the features and the combinations thereof described in the embodiments are not necessarily essential to the invention.

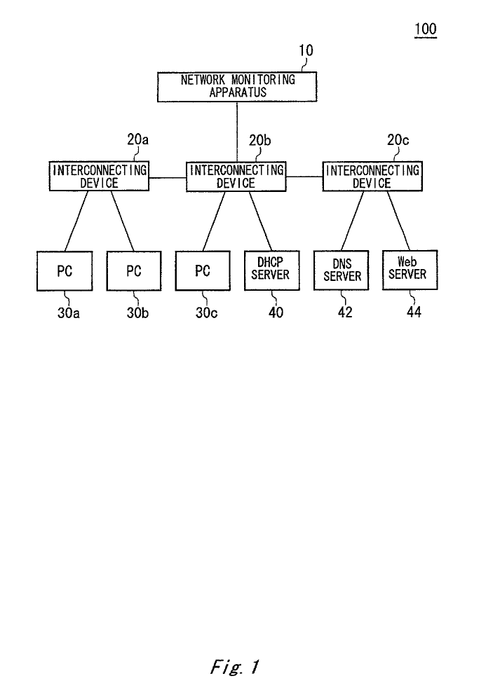

FIG. 1 shows a computer network 100 according to one embodiment of the present invention having a network monitoring apparatus 10 to monitor communication devices in the computer network 100; interconnecting devices 20a, 20b, and 20c to interconnect communication in the computer network 100; client computers, for example, PCs, 30a, 30b, and 30c to communicate in computer network 100; and server computers having server functions such as DHCP server 40, DNS server 42 and Web server 44. Interconnecting devices 20a, 20b, and 20c, client computers 30a, 30b, and 30c, DHCP server 40, DNS server 42 and Web server 44 are some examples of communication devices.

Network monitoring apparatus 10 detects the operations of the communication devices that communicate in computer network 100 and informs an administrator of computer network 100 of the detected operations of the communication devices. A notification file, i.e., a file stored in the network monitoring apparatus 10 (as described hereinafter) having a plurality of notifications therein, may be set by the administrator, or may be set at the time of shipment of the network monitoring apparatus 10 from the manufacture.

Network monitoring apparatus 10 stores the notification file and the notifications therein corresponding to the various operations of the communication devices in the computer network 100. Network monitoring apparatus 10 informs, i.e., notifies, of a detected operation by using a predetermined notification in the stored notification file that corresponds to the detected operation of the communication device that is being monitored. For example, the notifications in the notification file may be a display of one or more image indicating an operation or operations of the communication devices, a pop-up display, an e-mail transmission, generation of tones/sounds such as a buzzer, etc. Thus, the administrator can be rapidly and accurately informed of the operations of the communication devices in the computer network 100 by setting the notifications in the notification file based upon the respective operations of the detected communication devices. The administrator can, therefore, immediately cope with a failure when such failures occur in the communication devices in the computer network 100.

Network monitoring apparatus 10 monitors each of a plurality of communication devices in the computer network 100 at a different interval depending on the operation or a communication device type of the communication devices in the computer network 100. For example, network monitoring apparatus 10 monitors interconnecting devices 20a, 20b, and 20c, or communication devices, which serve an important role in computer network 100, such as DHCP server 40, DNS server 42 and Web server 44, at a short interval of time; and monitors client computers 30a, 30b, and 30c, or the like, at a comparatively long interval of time.

Further, network monitoring apparatus 10 in the present embodiment monitors the communication devices in the computer network 100 depending on a communication device type connected to connection ports of each of a plurality of interconnecting devices 20a, 20b, and 20c at each of different intervals of time. For example, network monitoring apparatus 10 monitors connection ports to which interconnecting devices 20a, 20b, and 20c, or communication devices like DHCP server 40, DNS server 42, and Web server 44, which serve an important role in computer network 100, are connected at a short interval. On the other hand, network monitoring apparatus 10 monitors the connection ports to which client computers 30a, 30b, and 30c are connected at a comparatively long interval.

Network monitoring apparatus 10 of the present embodiment, monitors the communication devices or the connection ports in the computer network 100 at suitable or desirable intervals. Network monitoring apparatus 10 monitors each of the plurality of communication devices in the computer network 100 at a different interval depending on the operation or the communication device type of the respective communication devices in the computer network 100. Network monitoring apparatus 10 monitors each of the plurality of connection ports of interconnecting devices 20a to 20c at a different interval depending on the communication device type of the respective communication devices connected to each of the plurality of connection ports of interconnecting devices 20a to 20c in the computer network 100. Therefore, it is possible to set a longer monitoring interval for a communication device or a connection port that does not need to be frequently monitored, and thereby reduce the communication traffic of the network monitoring apparatus 10 with the communication devices to be monitored in the computer network 100. Accordingly, the communication load due to communication monitoring traffic in computer network 100 can be reduced.

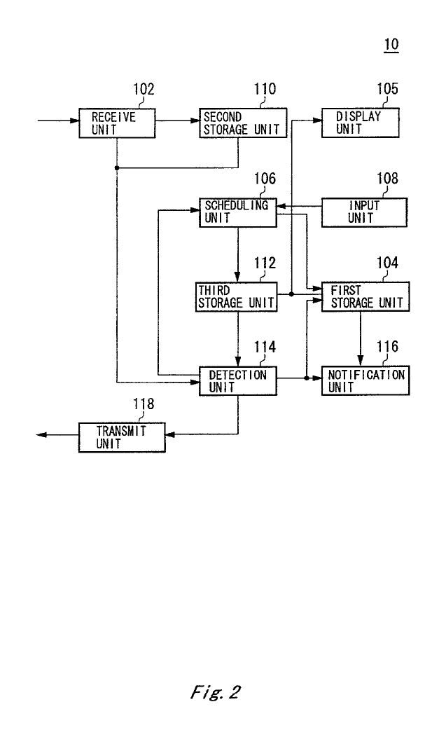

FIG. 2 shows the network monitoring apparatus 10 having a detection unit 114 to detect operations of the communication devices communicating in computer network 100; transmit unit 118 to transmit a detection signal to detect the operations of the communication devices with detection unit 114; receive unit 102 to receive a response signal corresponding to the detection signal from the communication devices; scheduling unit 106 to schedule a monitoring interval, which is an interval to monitor a communication device in the computer network 100 based on the operations of the communication device detected by detection unit 114; input unit 108 to input information that is inputted by the administrator to scheduling unit 106; display unit 105 to display a monitoring status scheduling screen or a monitored result in the communication devices in the computer network 100; and notification unit 116 to notify of the operations of the communication devices in the computer network 100 by using a predetermined notification in a stored notification file (described hereinafter) based on the operations of the communication devices in the computer network 100 detected by detection unit 114. Detection unit 114 is one example of the monitoring unit and monitors the communication devices in the computer network 100 by detecting the operations of the communication devices.

Network monitoring apparatus 10 is provided with a first storage unit 104 to store a notification file having a plurality of notifications to notify of respective operations corresponding to the operations of the communication devices in the computer network 100; second storage unit 110 to store one or more information signal, received from the communication devices, indicating the operations of the communication devices in the computer network 100; and third storage unit 112 to store one or more monitoring interval of the connection ports of interconnecting devices 20a, 20b, and 20c, or one or more monitoring interval of the communication devices in the computer network 100. The monitoring intervals are stored to correspond with the associated connection ports of interconnecting device 20a, 20b, or 20c, or the associated communication devices in the computer network 100.

Transmit unit 118 transmits one or more detection signal to detect the operations of the communication devices in the computer network 100 to be monitored based on requests of detection unit 114. Receive unit 102 receives a response signal from the communication devices in the computer network 100 in response to the detection signal. Detection unit 114 detects the operations of the communication devices in the computer network 100 based on the response signal received from the communication devices by receive unit 102.

For example, the transmit unit 118 transmits an ICMP echo request message by a ping command as a detection signal to the communication device to be monitored. When receive unit 102 receives the ICMP echo response message from the communication device being monitored, detection unit 114 detects that the communication device being monitored operates normally on computer network 100. When receive unit 102 does not receive the ICMP echo response message from the communication device being monitored, detection unit 114 detects that the communication device being monitored does not operate normally on computer network 100.

Receive unit 102 receives one or more information signal indicating the operations of the communication devices in the computer network 100 from the communication devices. Second storage unit 110 stores the information signal or signals received from the communication devices being monitored so as to correspond to the time when receive unit 102 received the one or more information signal. Detection unit 114 detects the operations of the communication devices being monitored by referring to the one or more information signal stored in second storage unit 110.

For example, receive unit 102 receives a link Up trap, a link Down trap, a cold Start trap, or the like, as examples of one or more information signal indicating the operations of the communication devices in the computer network 100. Second storage unit 110 stores the trap information that receive unit 102 receives from the communication devices being monitored so as to correspond to the time when receive unit 102 receives the trap information. Detection unit 114 detects the operations of the communication devices based on the trap information stored in second storage unit 110.

Detection unit 114 may request interconnecting devices 20a, 20b, and 20c to send information indicating communication traffic of each of the plurality of associated connection ports and detect the received communication traffic information as the operations of the interconnecting devices 20a, 20b, and 20c. Further, detection unit 114 may detect communication traffic of client computers 30a, 30b, and 30c, DHCP server 40, DNS server 42 or Web server 44, which may be connected to each of the plurality of connection ports of the interconnecting devices 20a, 20b, and 20c, by detecting communication traffic of each of the associated plurality of connection ports of interconnecting devices 20a, 20b, and 20c.

Detection unit 114 may detect each of a plurality of operations in a communication device in the computer network 100 at a different interval. For example, detection unit 114 detects whether or not the communication devices in the computer network 100 are operating at a shorter interval than an interval at which the communication traffic of the communication devices in the computer network 100 is detected. Detection unit 114 may detect each of the plurality of communication devices in the computer network 100 at a corresponding different interval. Detection unit 114 detects an operation of DHCP server 40, DNS server 42 or Web server 44 at a shorter interval than an interval at which an operation of client computer 30a 30b or 30c is detected.

Detection unit 114 may detect a communication status of each of the plurality of connection ports of interconnecting device 20a, 20b, or 20c in the computer network 100. Detection unit 114 detects the communication status of the respective connection ports to which DHCP server 40, DNS server 42, and Web server 44 may be connected at a shorter interval than the interval at which the communication status of the respective connection ports to which client computer 30a, 30b, and 30c may be connected is detected.

Notification unit 116 selects a predetermined notification from a notification file stored in first storage unit 104 based on the communication device operation detected by detection unit 114 and informs of an operation of the communication device in the computer network 100 with the selected notification. Notification unit 116 may notify the administrator of the operation of the communication device in the computer network 100 by displaying a predetermined image, i.e., a notification, indicating the communication device operation on display unit 105. Notification unit 116 may notify the administrator of an operation of the communication device by transmitting an e-mail to a predetermined mail address. Notification unit 116 may notify the administrator of an operation of a communication device by generating predetermined tones/sounds based upon the detected communication device operation.

Scheduling unit 106 may schedule a monitoring interval, which is an interval to monitor a communication device in the computer network 100, based on the operation of the communication device detected by detection unit 114. Third storage unit 112 stores a monitoring interval scheduled by scheduling unit 106 so as to correspond to the associated communication device in the computer network 100. Detection unit 114 monitors the communication device in the computer network 100 based on the monitoring interval stored in third storage unit 112.

Detection unit 114 may detect the communication device type as the communication device operation. Scheduling unit 106 schedules the monitoring interval of the communication device in the computer network 100 based on the detected communication device type. More specifically, detection unit 114 detects whether or not a server function operates in the communication device being monitored in the computer network 100 and detects whether the communication device being monitored in the computer network 100 is a client computer or a server computer. Scheduling unit 116 schedules an interval so that a monitoring interval of a server computer is shorter than a monitoring interval of a client computer. Detection unit 114 may detect a type of a server operation in the communication device being monitored in the computer network 100. Scheduling unit 106 may schedule the monitoring interval based on the server type detected by the detection unit 114.

Detection unit 114 may detect communication traffic of the communication device in the computer network 100 as the communication device operation. Scheduling unit 106 schedules the monitoring interval of the communication device being monitored in the computer network 100 based on the detected communication traffic. More particularly, detection unit 114 detects communication traffic of the communication device in the computer network 100 connected to each of the plurality of ports of interconnecting devices 20a, 20b, or 20c by detecting communication traffic of each of the associated plurality of connection ports of interconnecting device 20a, 20b, or 20c. Scheduling unit 106 schedules an interval so that the monitoring interval of a communication device being monitored in the computer network 100 with greater communication traffic is shorter than the monitoring interval of a communication device with lesser communication traffic.

Detection unit 114 may detect the communication device type of communication devices in the computer network 100 that are connected to each of the plurality of connection ports of interconnecting devices 20a, 20b, and 20c as associated communication device operation. Scheduling unit 106 schedules respective monitoring intervals of the plurality of connection ports of interconnecting device 20a, 20b, or 20c based on the detected communication device type. More particularly, detection unit 114 detects whether or not the server function operates in a communication device that is connected to one of the plurality of connection ports of interconnecting device 20a, 20b, or 20c in the computer network 100 and detects whether the communication device being monitored is a client computer or a server computer. Scheduling unit 106 schedules the associated monitoring interval so that the monitoring interval of a connection port to which a server computer is connected is shorter than a monitoring interval of a connection port to which a client computer is connected.

Detection unit 114 may detect communication traffic of each of the plurality of connection ports of interconnecting device 20a, 20b, or 20c in the computer network 100 as the operation of the associated communication device. Scheduling unit 106 schedules each monitoring interval of the plurality of connection ports of interconnecting device 20a, 20b, or 20c based on the detected communication traffic. For example, scheduling unit 106 may schedule an interval so that the monitoring interval of a connection port with greater communication traffic is shorter than the monitoring interval of a connection port with lesser communication traffic, or, alternatively, so that the monitoring interval of a connection port with greater communication traffic is longer than the monitoring interval of a connection port with lesser communication traffic.

According to network monitoring apparatus 10 of the present embodiment, the administrator is informed of the detected communication device operation in the computer network 100 by using a predetermined notification in a notification file that corresponds to the detected operation. Consequently, the administrator can rapidly and accurately grasp the operation of a communication device in the computer network 100 and can cope in a timely manner with a failure when such a failure occurs in a communication device in the computer network 100.

Further, according to network monitoring apparatus 10 in the present embodiment, it is possible to monitor a communication device in the computer network 100 at a different interval depending on the type or the operation of the communication device or the connection port of the interconnecting device 20a, 20b, or 20c to which the communication device may be connected. The monitoring interval of a communication device or a connection port to be monitored frequently in the computer network 100 can be short and the monitoring interval of a communication device or a connection port not to be monitored frequently can be long. Accordingly, communication traffic of network monitoring apparatus 10 with the communication device to be monitored in the computer network 100 can be reduced.

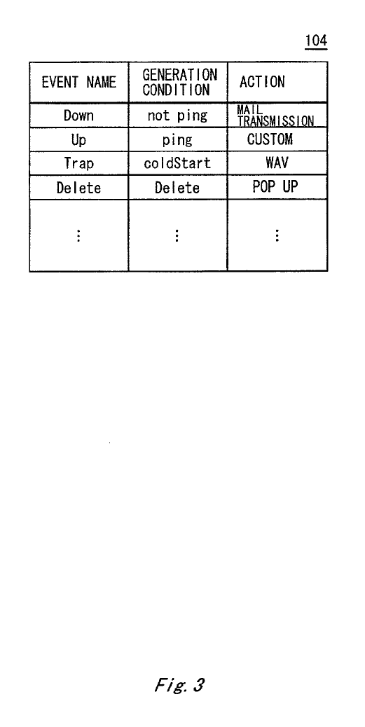

FIG. 3 shows a notification file stored in first storage unit 104 having an event name field, a generation condition field, and an action field. The event name field stores an event name to identify the communication device operation of a communication device in the computer network 100. The generation condition field stores generation conditions of an operation in a communication device, which is identified by the corresponding event name, so as to correspond to the associated event name. The action field stores a notification, which is an action by the network monitoring apparatus 10 that corresponds to an event name and is executed when an operation of a communication device in the computer network 100 that is identified from the associated event name is performed. The notification file stores the event name, generation condition and action based on information input from input unit 108 by the administrator.

When receive unit 102 does not receive an ICMP echo response message in response to an ICMP echo request message by a ping command, which is transmitted to a communication device to be monitored in the computer network 100 from transmit unit 118, detection unit 114 detects that the communication device that is being monitored does not operate normally on the computer network 100 and judges that the event name of the communication device is “Down”. Notification unit 116 refers to the notification file stored in first storage unit 104 and informs the administrator of the communication device operation by action “mail transmission”, which is stored so as to correspond to the event name “Down”.

An action “custom” combines a display of a selected image indicating the associated event name of an operation by a communication device in the computer network 100 with, for example, transmission of an e-mail notification and a notification customized by the administrator.

An action “WAV” is a notification by sound. The event name “Delete” is a deleted communication device operation. For example, when an ICMP echo response message is not received in response to a predetermined number of transmissions of an ICMP echo request message by the ping command, the detection unit 114 judges that the event name of the communication device operation in the computer network 100 is “Delete”.

According to network monitoring apparatus 10 in the present embodiment, since network monitoring apparatus 10 informs the administrator of a communication device operation in the computer network 100 by using a predetermined notification from the stored notification file, which is set, for example, by the administrator so as to correspond to the detected communication device operation, the administrator can easily recognize the detected communication device operation and, when a failure in the communication device occurs, the administrator can immediately cope with the failure in the computer network 100.

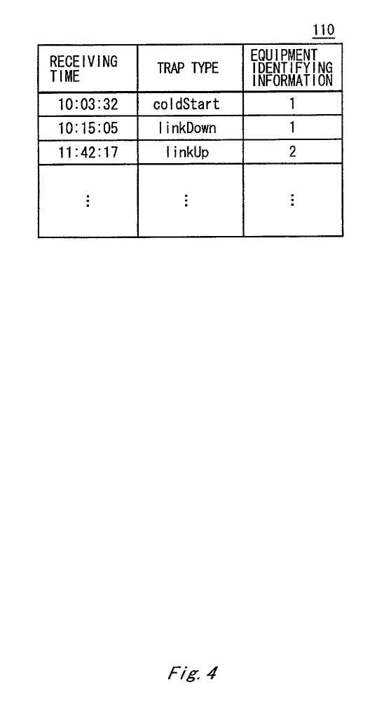

FIG. 4 is a data format of a trap information file stored in second storage unit 110. The trap information file has a receiving time field, a trap type field, and an equipment identifying information field. The receiving time field stores a time when network monitoring apparatus 10 receives a trap information from a communication device in the computer network 100. The trap type field stores the trap type received from the communication device by network monitoring apparatus 10. The equipment identifying information field stores the equipment identifying information of a communication device in the computer network 100 which transmitted the trap information.

In the present embodiment, “1” represents equipment identifying information of interconnecting device 20a, “2” represents equipment identifying information of interconnecting device 20b, “3” represents equipment identifying information of interconnecting device 20c, “4” represents equipment identifying information of client computer 30a, “5” represents equipment identifying information of client computer 30b, “6” represents equipment identifying information of client computer 30c, “7” represents the equipment identifying information of DHCP server 40, “8” represents the equipment identifying information of DNS server 42, “9” represents the equipment identifying information of Web server 44.

The trap information file in FIG. 4 shows that interconnecting device 20a operates at 32 seconds after 10:03 and an interface is down at 5 seconds after 10:15. When detection unit 114 detects the operation of interconnecting device 20a at 10:30, detection unit 114 refers to the trap information file stored in storage unit 110 and detects that the interface of interconnecting device 20a is down.

According to network monitoring apparatus 10 in the present embodiment, since the second storage unit 110 stores, in the trap information file, a history of the trap information that is received from the communication devices in the computer network 100 by network monitoring apparatus 10, detection unit 114 can accurately detect the operations of the communication devices in the computer network 100 by referring to the trap information file in which second storage unit 110 stores the trap history.

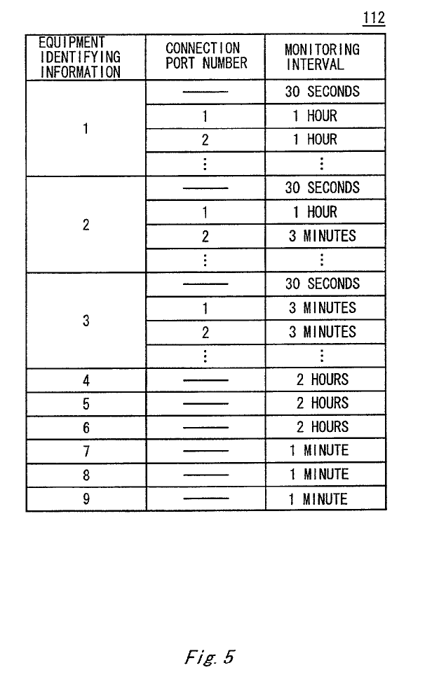

FIG. 5 is a data format of a monitoring interval file stored in third storage unit 112. The monitoring interval file has an equipment identifying information field, a port number field, and a monitoring interval field. The equipment identifying information field stores equipment identifying information of the communication devices in the computer network 100. The connection port number field stores a connection port number to identify a connection port of the interconnecting devices 20a, 20b, and 20c. The monitoring interval field stores a monitoring interval of each communication device or connection port in the computer network 100 so as to correspond to the associated communication device or connection port.

According to the monitoring interval file shown in FIG. 5, detection unit 114 monitors interconnecting devices 20a, 20b, and 20c at 30 seconds monitoring intervals. Detection unit 114 monitors client computers 30a, 30b, and 30c at 2 hours monitoring intervals. Detection unit 114 monitors DHCP server 40, DNS server 42 and Web server 44 at 1 minute monitoring intervals. Detection unit 114 monitors connection ports 1 and 2 of interconnecting device 20a, and connection port 1 of interconnecting device 20b at an hour monitoring interval. Detection unit 114 monitors connection port 2 of interconnecting device 20b, and connection ports 1 and 2 of interconnecting device 20c at three minutes monitoring interval.

Since network monitoring apparatus 10 can monitor the communication devices in the computer network 100 at respective different intervals according to the communication device type or the connection port of the device, communication traffic of network monitoring apparatus 10 with a communication device to be monitored in the computer network 100 can be reduced by making the monitoring interval of a communication device or connection port to be monitored frequently short and making the monitoring interval of a communication device or connection port not to be monitored frequently long.

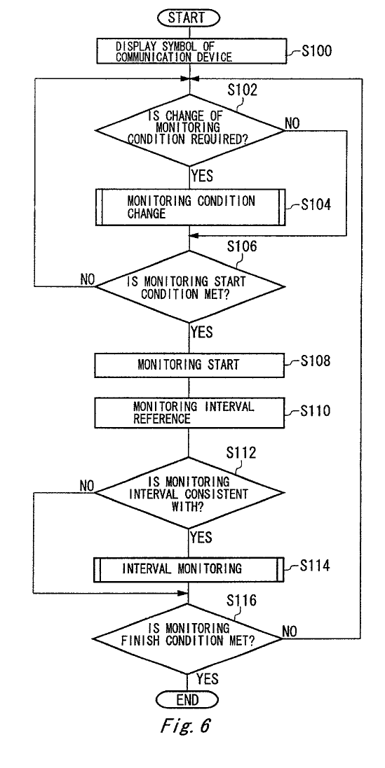

FIG. 6 is a flowchart of one example of a network monitoring method according to the present embodiment. Display unit 105 displays a symbol, which is an image indicating an operation of a communication device to be monitored in the computer network 100 (S100). The administrator may request change of a monitoring condition (described hereinafter) by selecting the displayed symbol. Scheduling unit 106 judges whether or not the administrator has requested change of the monitoring condition using input unit 108 (S102). When change of the monitoring condition is requested in S102, the scheduling unit 106 changes the monitoring condition as requested by the administrator (S104). When change of the monitoring condition is not requested in S102, the monitoring condition is not changed and the routine proceeds to S106.

Scheduling unit 106 refers to monitoring start conditions (described hereinafter) and judges whether or not a monitoring start condition is met (S106). When a monitoring start condition is not met in S106, the routine returns to S102. When a monitoring start condition is met in S106, monitoring of a communication device in the computer network 100 is started (SI 08).

Detection unit 104 refers to a monitoring interval of the monitoring condition (S110). Detection unit 114 judges whether or not the associated monitoring interval is consistent with the present monitoring start time, or the time passed since a previous monitoring time (S112). When the monitoring interval is consistent with time in S112, detection unit 114 monitors the communication device in the computer network 100 (S114). When the monitoring interval is not consistent with time in S112, the communication device is not monitored and the routine proceeds to S116.

Scheduling unit 106 refers to a finish condition of the monitoring (described hereinafter) and judges whether or not a monitoring finish condition is met (S116). When the monitoring finish condition is not met in S116, the routine returns to S102. When the monitoring finish condition is met in S116, monitoring of the communication device in the computer network 100 is finished.

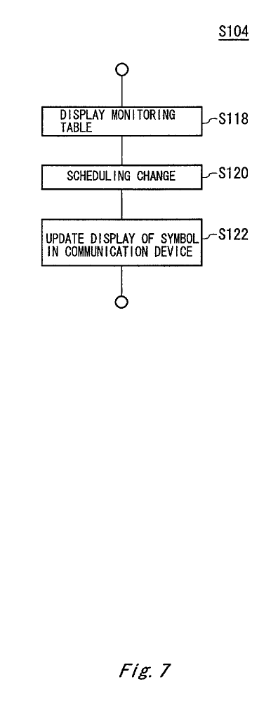

FIG. 7 is a flowchart of a monitoring condition changing process (S104). Display unit 105 displays a monitoring table that is created based on information stored in first storage unit 104 and third storage unit 112 (S118). The administrator inputs setting information of a monitoring condition from input unit 108 while referring to the monitoring table displayed on display unit 105. Scheduling unit 106 changes the previously set monitoring condition based on the new setting information input from input unit 108 (S120). The administrator may change the set monitoring condition. Display unit 105 updates the symbol displayed in S100, which is an image indicating the operation of a communication device to be monitored in the computer network 100, to display the updated symbol (S122). Display unit 105 updates the symbol based on the information of the changed monitoring condition.

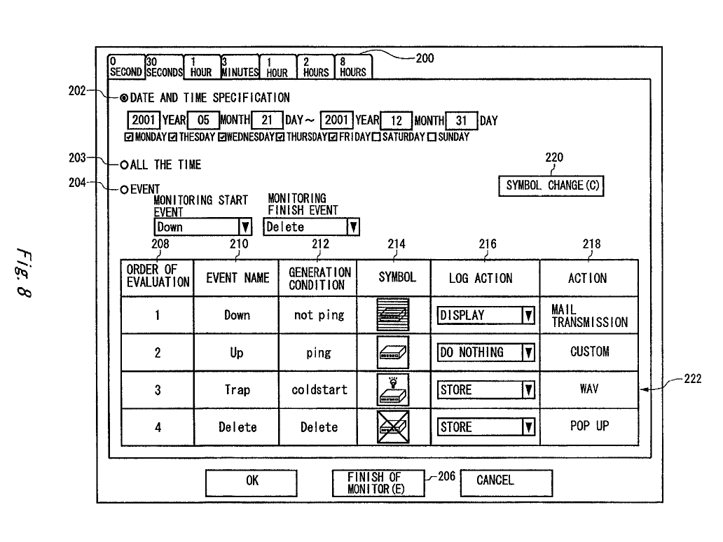

FIG. 8 is one example of a monitoring table displayed by display unit 105. Display unit 105 displays the monitoring table as shown in FIG. 8, using GUI, in S118. The administrator determines the monitoring interval of a communication device to be monitored in the computer network 100 by selecting a monitoring interval tab 200. The administrator determines a monitoring start condition and monitoring finish condition by selecting a date and time specification button 202, a continuous monitoring button for all the time 203, or an event button 204. When the administrator selects the event button 204, the administrator further inputs a monitoring start event and a monitoring finish event. The administrator may manually finish monitoring by pushing a monitoring finish button 206.

The administrator sets evaluation order 208, event name 210, generation condition 212, symbol 214, log action 216, and action 218 as monitoring content 222. Evaluation order 208 shows an order in which operations are to be evaluated in the communication devices in the computer network 100. Event name 210 shows an operation of a communication device in the computer network 100. Generation condition 212 shows a generating condition of the operation of the communication device which is identified by the associated event name. Symbol 214 shows a display image that is displayed by display unit 105 when the corresponding operation of the communication device, identified by the associated event name, is performed. The administrator selects or creates a desired symbol by pushing a symbol changing button 220.

Log action 216 shows a selected method of processing a log of the detected operation of a communication device in the computer network 100. For example, the processing method includes displaying the log, storing the log, or doing nothing. Action 218 shows a selected notification from the stored notification file, which is to be used to notify the administrator of an operation of the communication device when the associated operation of the communication device, identified by the corresponding event name, is performed.

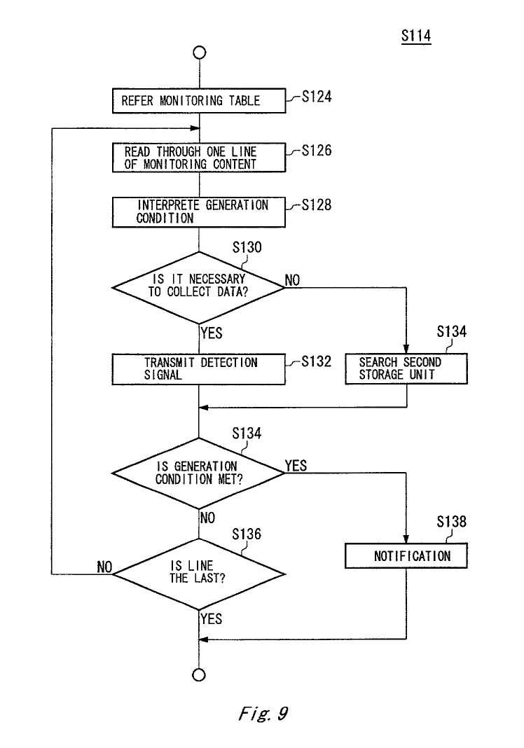

FIG. 9 is a flowchart of an interval monitoring process (S114). Detection unit 114 refers to the monitoring table (S124). Detection unit 114 reads one line of the monitoring content 222 in the evaluation order (S126), and interprets the generation condition of the operation of the communication device which is identified by the associated event name (S128). Detection unit 114 judges whether or not collection of data from the communication device to be monitored in the computer network 100 is required (S130). When detection unit 114 judges collection of data is necessary in S130, detection unit 114 makes transmit unit 118 transmit a detection signal to the communication device being monitored (S132). When the detection unit 114 judges collection of data is not necessary in S130, detection unit 114 searches the trap information stored in second storage unit 110 (S134).

Detection unit 114 judges whether or not the generation condition read in S126 is met based on a response signal to the detection signal transmitted by transmit unit 118, or the trap information stored in second storage unit 110 (S134). When generation condition is met in S134, notification unit 116 informs of the detected operation of the communication device being monitored based on the associated symbol, the log action and the selected action of the monitoring content 222 read in S126 (S138). When the generation condition is not met in S134, detection unit 114 judges whether or not the line read in S126 is the last line of monitoring content 222 (S136). When detection unit 114 judges that the line read in S126 is not the last line, detection unit 114 returns to S126. Further, when detection unit 114 judges that the line read in S126 is the last line, the interval monitoring processing is finished.

According to a network monitoring method of the present embodiment, the administrator can easily perform monitoring of communication devices in the computer network 100 and further can be provided with an environment that allows easy administration for the administrator of the computer network 100. The administrator rapidly and accurately can recognize operations of communication devices in the computer network 100 by appropriate setting of the notification file to relate to the respective operations of the communication devices.

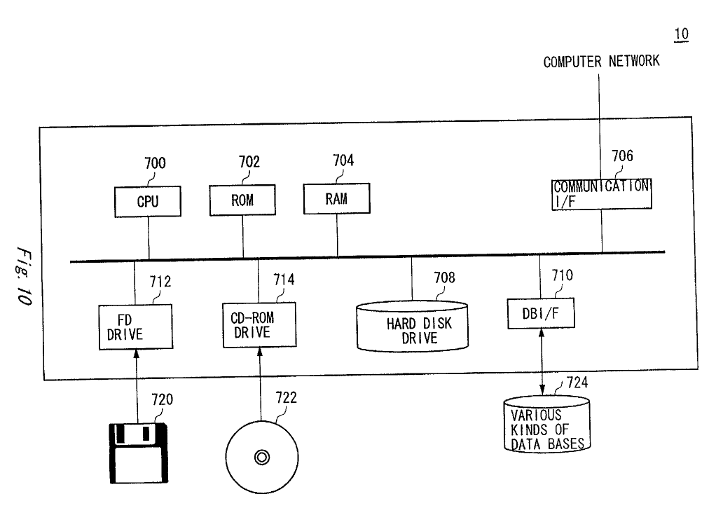

FIG. 10 is a diagram showing hardware components in network monitoring apparatus 10. Network monitoring apparatus 10 includes CPU 700, ROM 702, RAM 704, communication interface 706, hard disk drive 708, data base interface 710, floppy disk drive 712 and CD-ROM drive 714. CPU 700 operates based on a program stored in ROM 702 and RAM 704. Communication interface 706 communicates with interconnecting device 20a, 20b, or 20c, client computer 30a, 30b, or 30c, DHCP server 40, DNS server 42 or Web server 44 via a computer network. Data base interface 710 writes data into a data base and updates contents of the data base. Hard disk drive 708 stores setting information and a program so that CPU 700 operates.

Floppy disk drive 712 reads data or the program from floppy disk 720 and transmits the data or the program to CPU 700. CD-ROM drive 714 reads out data or a program from CD-ROM 722 and transmits the data or the program to CPU 700. Communication interface 706 connects to interconnecting device 20a, 20b, or 20c, client computer 30a, 30b, or 30c, DHCP server 40, DNS server 42, or Web server 44 to transmit/receive data. Data base interface 710 connects to various types of data bases 724 to transmit/receive data.

The program executed by CPU 700 is stored into a recording medium such as floppy disk 720 or CD-ROM 722 and provided to a user. The program stored in the recording medium may be compressed or decompressed. The program is installed from the recording medium into hard disk drive 708 and the program is read into RAM 704 to be executed by CPU 700.

The program stored into the recording medium and provided to the user, that is, the program installed into hard disk drive 708 has a receive module, a storage module, a display module, a scheduling module, an input module, a detection module, an notification module and a transmit module as a functional constitution. Explanation is omitted here since each module accesses a computer and processing performed by CPU 700 is identified as a function and an operation of corresponding members in network monitoring apparatus 10 which are described in connection with FIGS. 1 to 9.

Functions of one or all of operations of network monitoring apparatus 10 in all embodiments described in the present invention can be stored in floppy disk 720 or CD-ROM 722 as one example of the recording medium shown in FIG. 10.

These programs may directly be read from the recording medium into the RAM to be executed or may be read to the RAM to be executed after the programs is installed into the hard disk. Further, the programs may be stored into a single recording medium or a plurality of recording media. Furthermore, the program may be stored in an encoded style.

It is possible to use an optical recording medium of a DVD or a MD, an optical magnetic recording medium of a PD, a tape medium, a magnetic recording medium, a semiconductor memory such as an IC card or a miniature card, besides the floppy disk or the CD-ROM as the recording medium. The hard disk or the storage device of the RAM in a server system connected to a dedicated communication network or an internet may be used as the recording medium and a program may be provided to network monitoring apparatus 10 via a communication network. If the recording medium is used to manufacture/store network monitoring apparatus 10, it is obvious that to manufacture and sell as a business such a recording medium would be an infringement of a patent right based on the present application.

According to the present invention as aforementioned, it is possible to provide a network monitoring apparatus that notifies of an operation of a communication device to be monitored in a computer network by using a predetermined notification corresponding to a detected operation of the communication device being monitored.

Although the present invention has been described by way of exemplary embodiments, it should be understood that many changes and substitutions may be made by those skilled in the art without departing from the spirit and the scope of the present invention which is defined only by the appended claims.

1. A network monitoring apparatus for monitoring an interconnecting device that interconnects communication in a computer network, comprising:
a first storage unit having a plurality of notifications stored therein corresponding to each of a plurality of operations in said interconnecting device, respectively;
a detection unit that detects each of said operations in said interconnecting device; and
a notification unit that selects one of said notifications stored in said first storage unit based on said detected operation to notify of said detected operation of said interconnecting device by said selected notification.

2. A network monitoring apparatus as claimed in claim 1,
wherein said detection unit detects said each of said plurality of operations in said interconnecting device at a different interval.

3. A network monitoring apparatus as claimed in claim 2, wherein an interval for detecting whether or not said interconnecting device is operating is shorter than an interval for detecting communication traffic in said interconnecting device.

4. A network monitoring apparatus as claimed in claim 1,
wherein said detection unit transmits a detection signal to said interconnecting device and detects said operations of said interconnecting device based on a response signal to said detection signal from said interconnecting device.

5. A network monitoring apparatus as claimed in claim 1, further comprising: a second storage unit for storing an information signal indicating an operation of said interconnecting device, said information signal being received from said interconnecting device and stored corresponding to a time when said information signal is received, wherein said detection unit detects said operations of said interconnecting device by referring to said information signal stored in said second storage unit.

6. A network monitoring apparatus as claimed in claim 1,
wherein said detection unit detects said each of said operations of a plurality of said interconnecting devices at a different interval.

7. A network monitoring apparatus as claimed in claim 1,
wherein said interconnecting device has a plurality of connection ports to which a plurality of communication devices are respectively connected, and said detection unit detects a communication status of each of said plurality of connection ports in said interconnecting device at a different interval.

8. A network monitoring apparatus as claimed in claim 1,
wherein said notification unit transmits an e-mail to a predetermined e-mail address as said selected one of said notifications to notify of said detected operation of said interconnecting device.

9. A network monitoring apparatus for monitoring a plurality of communication devices that communicate in a computer network, comprising:
a detection unit that detects an operation of a predetermined communication device of said plurality of communication devices;
a scheduling unit that schedules a monitoring interval, which is an interval for monitoring said predetermined communication device, based on said operation detected by said detection unit; and
a monitoring unit for monitoring said predetermined communication device based on said monitoring interval set by said scheduling unit.

10. A network monitoring apparatus claimed in claim 9, wherein
said detection unit detects a type of said predetermined communication device as said operation of said predetermined communication device and said scheduling unit schedules said monitoring interval for said predetermined communication device based on said type of said predetermined communication device detected by said detection unit.

11. A network monitoring apparatus claimed in claim 10,
wherein said scheduling unit schedules said monitoring interval for a server computer type of said predetermined communication device to be shorter than said monitoring interval for a client computer type of said predetermined communication device.

12. A network monitoring apparatus claimed in claim 9, wherein
said detection unit detects communication traffic of said predetermined communication device as said operation of said predetermined communication device and said scheduling unit schedules said monitoring interval for said predetermined communication device based on said communication traffic detected by said detection unit.

13. A network monitoring apparatus claimed in claim 9, wherein
said predetermined communication device has a plurality of connection ports to which a plurality of communication devices are respectively connected, and said scheduling unit schedules a monitoring interval, which is a corresponding interval for monitoring a communication status of each of said plurality of connection ports of said predetermined communication device, respectively.

14. A network monitoring apparatus claimed in claim 13,
wherein said detection unit detects a corresponding communication device type connected to each of said plurality of connection ports, respectively, as said operation of said predetermined communication device, and
said scheduling unit respectively schedules said monitoring interval of each of said plurality of connection ports based on said corresponding communication device type detected by said detection unit.

15. A network monitoring apparatus claimed in claim 14,
wherein said scheduling unit schedules said monitoring interval for a first connection port to which a server computer is connected to be shorter than said monitoring interval for a second connection port to which a client computer is connected.

16. A network monitoring apparatus claimed in claim 13, wherein
said detection unit detects respective communication traffic for each of said plurality of connection ports and said scheduling unit respectively schedules said monitoring interval for each of said plurality of connection ports based on said communication traffic detected by said detection unit.

17. A computer-readable medium storing a network monitoring program for a computer to monitor an interconnecting device that interconnects communication in a computer network, said program comprising:
a storage module operable to make said computer store a plurality of notifications to notify of each of a plurality of operations in said interconnecting device, respectively;
a detection module operable to make said computer detect each of said operations in said interconnecting device; and
a notification module operable to make said computer select one of said notifications stored in said computer based on said detected operation and to notify of said detected operation in said interconnecting device by said selected notification.

18. A computer-readable medium storing a network monitoring program claimed in claim 17, wherein said detection module is operable to make said computer detect said each of said plurality of operations in said interconnecting device at a different interval.

19. A computer-readable medium storing a network monitoring program claimed in claim 18, wherein said detection module makes said computer detect each of said plurality of operations in a plurality of said interconnecting devices at a different interval.

20. A computer-readable medium storing a network monitoring program for a computer that monitors a plurality of communication devices communicating in a computer network, the program comprising:
a detection module operable to make said computer detect an operation of a predetermined communication device of said plurality of communication devices;
a scheduling module operable to make said computer schedule a monitoring interval, which is an interval for monitoring said predetermined communication device, based on said operation detected by said computer; and
a monitoring module operable to make said computer monitor said predetermined communication device based on said monitoring interval scheduled by said scheduling module.

21. A computer-readable medium storing a network monitoring program claimed in claim 20, wherein said detection module is operable to make said computer detect a type of said predetermined communication device as said operation of said predetermined communication device; and said scheduling module is operable to make said computer schedule said monitoring interval for said predetermined communication device based on said type of said predetermined communication device detected by said computer.

22. A network monitoring program claimed in claim 21, wherein said detection module is operable to make said computer detect communication traffic of said predetermined communication device; and said scheduling module is operable to make said computer schedule said monitoring interval of said predetermined communication device based on said communication traffic detected by said computer.

23. A network monitoring method of monitoring an interconnecting device that interconnects communication in a computer network, the method comprising:
storing a plurality of notifications to notify of each of a plurality of operations in said interconnecting device, respectively;
detecting an operation in said interconnecting device; and
selecting one of said stored notifications based on said detected operation and notifying of said detected operation of said interconnecting device by said selected notification.

24. A network monitoring method of monitoring a plurality of communication devices that communicate in a computer network, the method comprising: detecting an operation of a predetermined communication device of said plurality of communication devices;
scheduling a monitoring interval, which is an interval at which said predetermined communication device is monitored, based on said detected operation; and
monitoring said predetermined communication device based on said monitoring interval.
